(19) United States
(12) Patent Application Publication
(10) Pub. No.: US 2013/0231894 A1
(43) Pub. Date: Sep. 5, 2013

(54) METHOD AND APPARATUS FOR PROVIDING BATTERY INFORMATION

(71) Applicants: Pekka Pääkkönen, Oulu (FI); Ville Könönen, Oulu (FI); Arttu Lämsä, Oulu (FI); Jussi Liikka, Oulu (FI)

(72) Inventors: Pekka Pääkkönen, Oulu (FI); Ville Könönen, Oulu (FI); Arttu Lämsä, Oulu (FI); Jussi Liikka, Oulu (FI)

(73) Assignee: NOKIA CORPORATION, Espoo (FI)

(21) Appl. No.: 13/409,845

(22) Filed: Mar. 1, 2012

(51) Int. Cl. G06F 15/00

(52) U.S. Cl. 702/183

(57) ABSTRACT

A method, apparatus and computer program product are provided for causing battery information, such as use time and/or recharging time estimation and/or battery condition estimation, to be provided based upon data regarding battery performance that has been collected from a plurality of devices. In the context of a method, a request for battery information may be received. The request includes an identification of a device type, and the battery information includes at least one of a use time estimate or a recharging time estimate. The method may also determine the battery information that was requested based upon data regarding at least one of use time or recharging time for a plurality of different devices of the device type. The method may also cause the battery information to be provided. Corresponding apparatuses and computer program products are also provided.

### TECHNOLOGICAL FIELD

Some example embodiments of the present invention relate generally to energy management and, more particularly, relate to the provision of battery information including, for example, use time and recharging time estimation and/or battery condition estimation.

### BACKGROUND

Mobile terminals, such as mobile telephones, mobile computers, portable digital assistants (PDAs), pagers, laptop computers, gaming devices and other types of mobile electronic systems, may execute a variety of software applications. Mobile terminals are generally supplied power from a battery such that execution of the software applications draws power from the battery. While a mobile terminal may be recharged from time to time, a user may be interested in the remaining lifetime of the battery, particularly in an instance in which the user is unable to currently recharge the battery. In this regard, the rate at which a battery is discharged depends, at least in part, upon the particular software application(s) being executed by the mobile terminal since the energy consumption of various software applications may vary dramatically. Indeed, some software applications may consume significantly more energy and therefore more quickly dissipate the battery than other software applications.

In many instances, however, a user is unaware of the energy consumed by a software application. As such, battery monitoring applications have been introduced that may display the remaining energy in the battery. The battery monitoring applications may map the remaining energy in the battery to use time estimates for different applications, such as voice calls, music playback, web browsing, etc. As such, a user can determine that a battery with a predefined percentage of its original charge correlates to X minutes of voice calls, Y minutes of music playback, or Z minutes of internet browsing. As such, users may adapt their behavior based upon the energy consumption of the various software applications, at least until the battery of the mobile terminal is able to be recharged. In addition to the provision of use time estimates, battery monitoring applications may provide recharging time estimates that provide an indication of the approximate time that will be required in order to recharge the battery from its current partially depleted state to a fully charged state.

While battery monitoring applications are useful for providing use time and recharging time estimation, battery monitoring applications may be unable to accurately estimate the use time for an application that is newly installed and for which the energy and/or power requirements are unknown. Indeed, battery monitoring applications may be unable to accurately estimate the use time for a newly installed application for a day or more following its installation, thereby limiting the utility of the battery monitoring application in the interim.

Similarly a battery monitoring application for a new device may be unable to provide accurate recharging time estimates for a period of days or even weeks depending upon the recharging behavior of the user. Additionally, a battery monitoring application may provide information regarding the battery condition or health. However, it may be difficult for a battery monitoring application to identify that a new device has a malfunctioning, e.g., a bad, battery for some period of time, e.g., days or weeks, to permit the battery monitoring application to collect historical data from which to identify a identify a bad battery.

### BRIEF SUMMARY

A method, apparatus and computer program product are therefore provided according to some embodiments of the present invention for providing battery information, such as use time and/or recharging time estimation and/or battery condition estimation, based upon data regarding battery performance that has been collected from a plurality of devices. As such, the method, apparatus and computer program product of an example embodiment may be able to quickly provide battery information for a new device and/or a new application. As such, users may be able to take into account the battery information in order to make decisions regarding application usage and recharging behavior, even in instances in which the device is newly activated or an application has been recently installed.

In one embodiment, a method is provided that includes receiving a request for battery information. The request includes an identification of a device type, and the battery information includes at least one of a use time estimate or a recharging time estimate. The method of this embodiment also determines the battery information that was requested based upon data regarding at least one of use time or recharging time for a plurality of different devices of the device type. The method of this embodiment also causes the battery information to be provided.

In another embodiment, an apparatus is provided that includes at least one processor and at least one memory including computer program code with the at least one memory and the computer program code configured to, with the at least one processor, cause the apparatus to at least receive a request for battery information. The request includes an identification of a device type, and the battery information includes at least one of a use time estimate or a recharging time estimate. The at least one memory and the computer program code of this embodiment are also configured to cause the apparatus to determine the battery information that was requested based upon data regarding at least one of use time or recharging time for a plurality of different devices of the device type. The at least one memory and the computer program of one embodiment are also configured to cause the apparatus to cause the battery information to be provided.

In a further embodiment, a computer program product is provided that includes at least one computer-readable storage medium having computer-executable program code portions stored therein with the computer-executable program code portions including program instructions configured to receive a request for battery information. The request includes an identification of a device type, and the battery information includes at least one of a use time estimate or a recharging time estimate. The computer-executable program code portions of this embodiment include program instructions configured to determine the battery information that was requested based upon data regarding at least one of use time or recharging time for a plurality of different devices of the device type. The computer-executable program code portions of this embodiment also include program instructions configured to cause the battery information to be provided.

In yet another embodiment, an apparatus is provided that includes means for receiving a request for battery information. The request includes an identification of a device type, and the battery information includes at least one of a use time estimate or a recharging time estimate. The apparatus of this embodiment also includes means for determining the battery information that was requested based upon data regarding at least one of use time or recharging time for a plurality of different devices of the device type. The apparatus of this embodiment also includes means for causing the battery information to be provided.

In one embodiment, a method is provided that includes causing issuance of a request for battery information. The request includes an identification of a device type. The battery information includes at least one of a use time estimate or a recharging time estimate. The method of this embodiment also receives the battery information that was requested based upon data regarding at least one of use time or recharging time for a plurality of different devices of the device type. The method of this embodiment also causes the battery information to be presented.

In another embodiment, an apparatus is provided that includes at least one processor and at least one memory including computer program code with the at least one memory and the computer program code configured to, with the at least one processor, cause the apparatus to at least cause issuance of a request for battery information. The request includes an identification of a device type. The battery information includes at least one of a use time estimate or a recharging time estimate. The at least one memory and the computer program code of this embodiment are also configured to, with the at least one processor, cause the apparatus to receive the battery information that was requested based upon data regarding at least one of use time or recharging time for a plurality of different devices of the device type. The at least one memory and the computer program code of this embodiment are also configured to, with the at least one processor, cause the apparatus to causes the battery information to be presented.

In a further embodiment, a computer program product is provided that includes at least one computer-readable storage medium having computer-executable program code portions stored therein with the computer-executable program code portions including program instructions configured to cause issuance of a request for battery information. The request includes an identification of a device type. The battery information includes at least one of a use time estimate or a recharging time estimate. The computer-executable program code portions of this embodiment also include program instructions configured to receive the battery information that was requested based upon data regarding at least one of use time or recharging time for a plurality of different devices of the device type. The computer-executable program code portions of this embodiment also include program instructions configured to cause the battery information to be presented.

In yet another embodiment, an apparatus is provided that includes means for causing issuance of a request for battery information. The request includes an identification of a device type. The battery information includes at least one of a use time estimate or a recharging time estimate. The apparatus of this embodiment also includes means for receiving the battery information that was requested based upon data regarding at least one of use time or recharging time for a plurality of different devices of the device type. The apparatus of this embodiment also includes means for causing the battery information to be presented.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described some embodiments of the invention in general terms, reference will now be made to the accompanying drawings, which are not necessarily drawn to scale, and wherein:

FIG. 1 is a block diagram of a system in accordance with an example embodiment of the present invention;

FIG. 2 is a block diagram illustrating an apparatus that may be specifically configured in accordance with an example embodiment of the present invention;

FIG. 3 is a signaling flow diagram illustrating the authentication of a mobile terminal and the subsequent provision of battery information from the mobile terminal to the database server in accordance with an example embodiment of the present invention;

FIG. 4 is a flow chart illustrating the operations performed by a database server in response to a request for user-specific battery information in accordance with an example embodiment of the present invention;

FIG. 5 is a signaling flow diagram of a request for user-specific battery information in accordance with an example embodiment of the present invention;

FIG. 6 is a flow chart illustrating the operations performed by an apparatus embodied by a mobile terminal in regards to the request for user-specific battery information in accordance with an example embodiment of the present invention;

FIG. 7 is a flow chart illustrating the operations performed by an apparatus embodied by a database server in response to a request for battery information for a specific type of device in accordance with an example embodiment of the present invention;

FIG. 8 is a signaling flow diagram illustrating a request for battery information for a specific type of device in accordance with an example embodiment of the present invention;

FIG. 9 is a flow chart illustrating the operations performed by an apparatus embodied by a mobile terminal in regards to the request for battery information for a specific type of device in accordance with an example embodiment of the present invention;

FIG. 10 is a flow chart illustrating the operations performed in order to determine the type of battery charger, e.g., a high power battery charger or a low power battery charger, in accordance with an example embodiment of the present invention;

FIG. 11 is a graphical representation of a decrease in current flow and the minimum current provided by one example of a charger; and

FIG. 12 is a Markov chain illustrating a recharging process.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

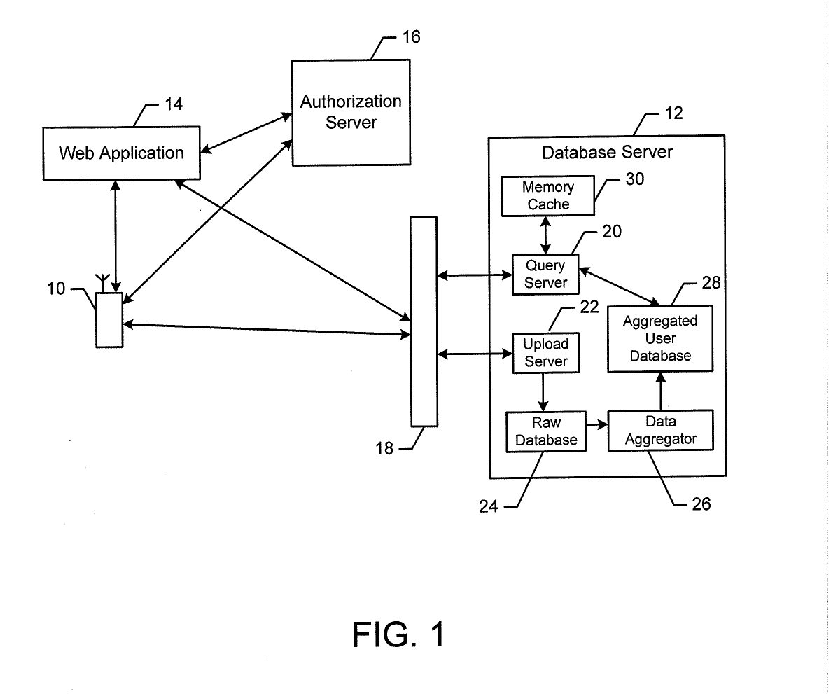

A system for collecting battery information from one or more mobile terminals 10 and for, in turn, providing the battery information to the mobile terminals is depicted in FIG. 1. Various types of mobile terminals may be configured in accordance with an example embodiment including, for example, a mobile communication device such as, for example, a mobile telephone, portable digital assistant (PDA), pager, laptop computer, tablet computer, or any of numerous other hand held or portable communication devices, computation devices, content generation devices, content consumption devices, or combinations thereof.

In accordance with an example embodiment, a mobile terminal 10 may be configured to provide battery information to a database server 12. In this regard, the mobile terminal and the database server may communicate via a wireless or a wireline connection, such as via a cellular network. Although a single mobile terminal is depicted in FIG. 1, the database server may receive battery information from a plurality of mobile terminals. As described below, the battery information that may be provided by a mobile terminal to a database server may include energy statistics including the power consumed by an application, the use time remaining for an application prior to consuming the energy stored in a battery or the like. Additionally, or alternatively, the battery information that is provided to the database server may include charging information including, for example, a charging model and an indication of the battery health.

As also described below, the mobile terminal 10 may request battery information, such as a use time estimate and/or a recharging time estimate, from the database server 12. The mobile terminal may request battery information that is specific to a type of device, such as a specific type of mobile terminal, but that is not specific to the user. The mobile terminal may communicate directly with the database server to request and receive the battery information. Additionally or alternatively, the mobile terminal may request battery information that is specific to the user. In this instance, the user of the mobile terminal may initially be authenticated prior to the provision of the requested battery information. Although the user of the mobile terminal may be authenticated in various manners, the system of one embodiment includes a web application 14 executed by a web server that facilitates the authentication of the user and, in turn, the request for and the provision of user-specific battery information to the mobile terminal. In this regard, the mobile terminal and the web application may communicate with an authorization server 16 in order to authenticate the user of the mobile terminal. Thereafter, the web application may query the database server for the user-specific battery information and may, upon receipt of the user-specific battery information, may provide the mobile terminal with the user-specific battery information, such as via a web page presented upon the display of the mobile terminal. In another embodiment, the mobile terminal may communicate directly with the authorization server in order to authenticate the user and may, in turn, communicate directly with the mobile terminal in order to request and, in turn, receive user-specific battery information without reliance upon a web application.

In the illustrated embodiment, the system also includes a fire wall 18 that protects the database server 12. The database server may be configured in various manners including configuration as a single server or as a plurality of servers that interwork with one another. In one embodiment, the database server includes an upload server 22 for receiving battery information from the plurality of mobile terminals 10, such as via an upload server application programming interface (API). The upload server may receive the battery information from the plurality of mobile terminals and may store the battery information in a raw database 24. The database server may also include or be configured to provide a data aggregator 26 to aggregate the battery information and to thereafter store the aggregated battery information in an aggregated user database 28.

The battery information that is provided by the plurality of mobile terminals 10 may be associated with and aggregated in accordance with the type of device, that is, the type of mobile terminal that is providing the battery information, and, in some embodiments, may be associated with and aggregated in accordance with the user of the mobile terminal. As such, the database server 12 may aggregate the battery information provided by the plurality of mobile terminals based upon the type of device that is providing the battery information. Thus, the battery information provided by mobile terminals of a first device type may be aggregated and the battery information provided by mobile terminals of a second device type may be separately aggregated. Additionally, battery information that is provided by a mobile terminal for which a user identity is also provided may also be aggregated based upon the identity of the user. Thus, the database server may store battery information based upon the device type and also based upon the user identity.

A mobile terminal 10 may thereafter query the database server 12 for battery information. The query may relate to battery information that is not specific to a user and the query may, instead, relate to the battery information for a respective type of device. As such, a mobile terminal may communicate directly, such as via the firewall 18, with the database server 12 and, in one embodiment, with the query server 20, such as via a query server API, in order to request the battery information. The database server may then obtain the requested battery information from the aggregated user database 28 and may provide the mobile terminal with the requested battery information. Alternatively, the mobile terminal may request user-specific battery information. The mobile terminal of one embodiment may request user-specific battery information via a web application 14 that authenticates the user and that issues the request for user-specific battery information to the database server. In response to authentication of the user, the database server and, more particularly, the query server 20, such as via a query server API, may access the user-specific battery information from the aggregated user database and may provide the user-specific battery information, such as via the web application, to the mobile terminal.

As such, a mobile terminal 10 may receive battery information that may guide the usage of the mobile terminal so as to judiciously utilize the remaining energy stored within the battery and to provide for recharging of the battery in a timely manner. Since the database server 12 determines at least some of the battery information based upon battery information collected from a plurality of mobile terminals, a mobile terminal may also be able to retrieve relevant battery information for a respective application almost immediately upon the installation of the respective application, such as upon or even prior to downloading of an application from an application store. Additionally, reliable information regarding the battery health may be obtained from the database server based upon battery information provided by many mobile terminals such that the condition of a battery may be more accurately determined, even in instances in which the battery is unhealthy and is performing in an unpredictable manner.

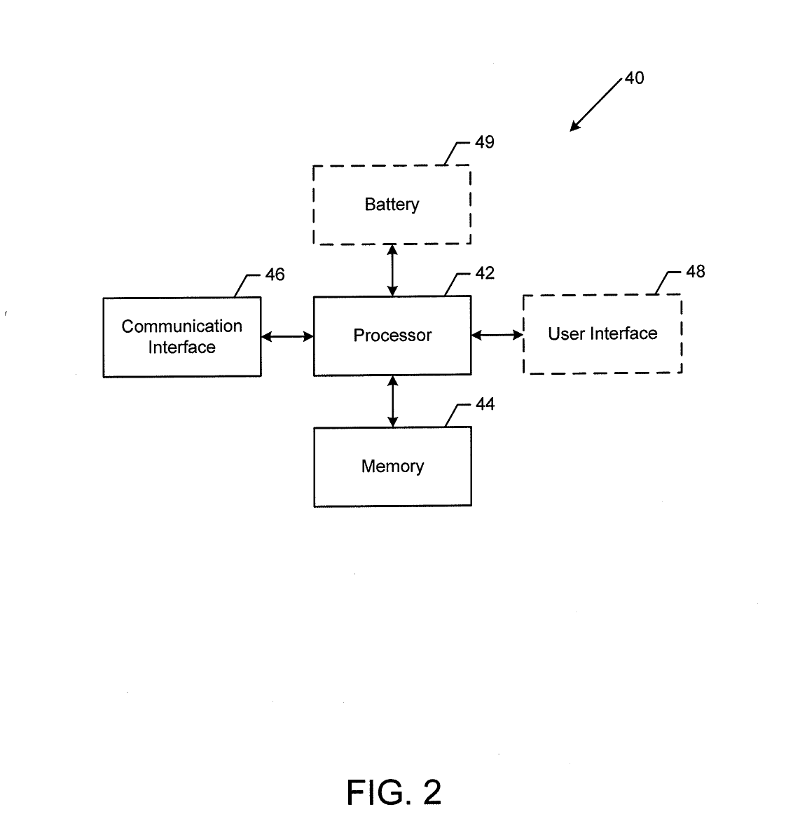

Referring to FIG. 2, an apparatus 40 that may be configured to function as a mobile terminal 10 or a database server 12 is illustrated. The apparatus includes various means, such as a processor 42, memory 44, communication interface 46 for performing the various functions herein described. In an instance in which the apparatus is embodied by a mobile terminal, the apparatus may also optionally include a user interface 48 and a battery 39 for providing power to the other components of the apparatus, such as the processor, the memory, the communication interface and the user interface. These means of the apparatus as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory) that is executable by a suitably configured processing device (e.g., the processor), or some combination thereof.

The processor 42 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor comprises a plurality of processors. In an example embodiment, the processor is configured to execute instructions stored in the memory 44 or otherwise accessible to the processor. These instructions, when executed by the processor, may cause the apparatus to perform one or more of the functionalities of the mobile terminal 10 or the database server 12 as described herein. As such, whether configured by hardware or software methods, or by a combination thereof, the processor may represent an entity configured to perform operations according to embodiments of the present invention when configured accordingly. Thus, for example, when the processor is embodied as an ASIC, FPGA or the like, the processor may comprise specifically configured hardware for conducting one or more operations described herein. Alternatively, as another example, when the processor is embodied as an executor of instructions, the instructions may specifically configure the processor to perform one or more algorithms and operations described herein.

The memory 44 may include, for example, non-transitory volatile and/or non-volatile memory. Although illustrated in FIG. 2 as a single memory, the memory may comprise a plurality of memories. The memory may comprise volatile memory, non-volatile memory, or some combination thereof. In this regard, the memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory may be configured to store information, data, applications, instructions, or the like for enabling the mobile terminal to carry out various functions in accordance with some example embodiments of the present invention. For example, in at least some embodiments, the memory is configured to buffer input data for processing by the processor 42. Additionally or alternatively, in at least some embodiments, the memory is configured to store program instructions for execution by the processor. The memory may store information in the form of static and/or dynamic information.

The communication interface 46 may be embodied as any device or means embodied in hardware, a computer program product comprising computer readable program instructions stored on a computer readable medium (e.g., the memory 44) and executed by a processing device (e.g., the processor 42), or a combination thereof that is configured to receive and/or transmit data from/to a remote device over a network. In this regard, the communication interface may be configured to transceive data over a public land mobile network (PLMN) network (e.g., a cellular network implementing universal mobile telecommunications service (UMTS) terrestrial radio access network (UTRAN) and/or evolved UTRAN (E-UTRAN) standards) operated by a network operator. In at least one embodiment, the communication interface is at least partially embodied as or otherwise controlled by the processor. In this regard, the communication interface may be in communication with the processor, such as via a bus. The communication interface may include, for example, an antenna, a transmitter, a receiver, a transceiver and/or supporting hardware or software for enabling communications with other entities of the system. The communication interface may be configured to receive and/or transmit data using any protocol that may be used for communications between computing devices of the system. The communication interface may additionally be in communication with the memory and/or user interface 48, such as via a bus.

In the context of a mobile terminal 10, the user interface 48 may be in communication with the processor 42 to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. The user interface may be in communication with the memory 44 and/or communication interface 46, such as via a bus. It is noted that the apparatus need not include a user interface and, indeed, in the context of a database server 12, the user interface may be eliminated.

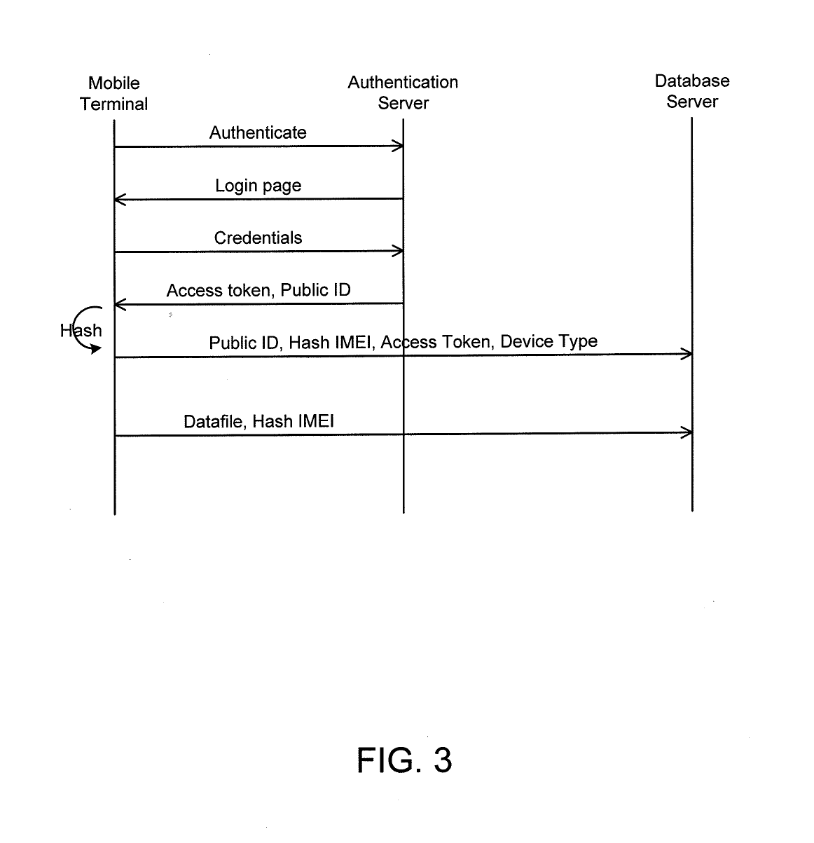

As noted above, the method, apparatus and computer program product of an example embodiment may require a user of a mobile terminal to be authenticated prior to providing the mobile terminal 10 with user-specific battery information. Although the user may be authenticated in various manners, one technique for authenticating the user of a mobile terminal is illustrated in FIG. 3. Initially, a user of a mobile terminal may initiate the authentication process with an authentication server 16 and be provided with a log in page via which a user may enter authentication credentials, such as a user name, a password or the like. Based upon the credentials provided by the user of the mobile terminal, the authentication server may generate an access token that is unique to the user of the mobile terminal and is associated with a public identity (ID) of the user of the mobile terminal. The mobile terminal, such as the processor 42, may generate a hash value, such as by generating a hash of a unique identifier of the mobile terminal, such as the international mobile equipment identity (IMEI), and a time stamp. The mobile terminal, such as the processor, may then cause the public ID of the user, the hash value, the access token, an indication of the device type and optionally the IMEI of the mobile terminal to be provided to the database server 12.

The database server 12 of an example embodiment may then store the information provided by the mobile terminal 10, such as in a user mapping table and a users daily statistics table maintained, for example, in the memory cache 30 of the database server. The user mapping table may include a mapping between the public identifier of the user and a unique user registration in the form of a registration ID. As such, the user mapping table may include the registration ID, the public ID, the IMEI and an indication that the device of the user that is active. By maintaining a mapping between the public ID of the user, the registration ID and the device identity, e.g., IMEI, a single user may be associated with multiple devices so as to facilitate a per user analysis in addition to or instead of a per device analysis. The users daily statistics table may include a mapping between a registration ID and a hash of the mobile device. As such, the user's table may include the registration ID, the hash value and a country code.

Once the user has been authenticated, the mobile terminal 10 may provide data, such as battery information, to the database server 12. For example, the mobile terminal may provide information regarding the power consumed by an application and the use time for an application for storage in the users daily statistics table as well as the charging model for the mobile terminal, the battery health or the like. Along with the data, such as the battery information, the mobile terminal may provide the database server with a hash value so as to permit authentication of the user of the mobile terminal, as shown in FIG. 3. Following authentication of the user of the mobile terminal, the database server 12, such as the upload server 22, may store the data, such as the battery information, within the raw database 24 for subsequent aggregation and storage by the aggregated user database 28. As described above, this data may be aggregated along with other similar battery information for the same type of device so as to provide device-specific battery information. Additionally, or alternatively, the data, such as the battery information, may be aggregated with other data, such as battery information, provided by the user so as to provide user-specific battery information.

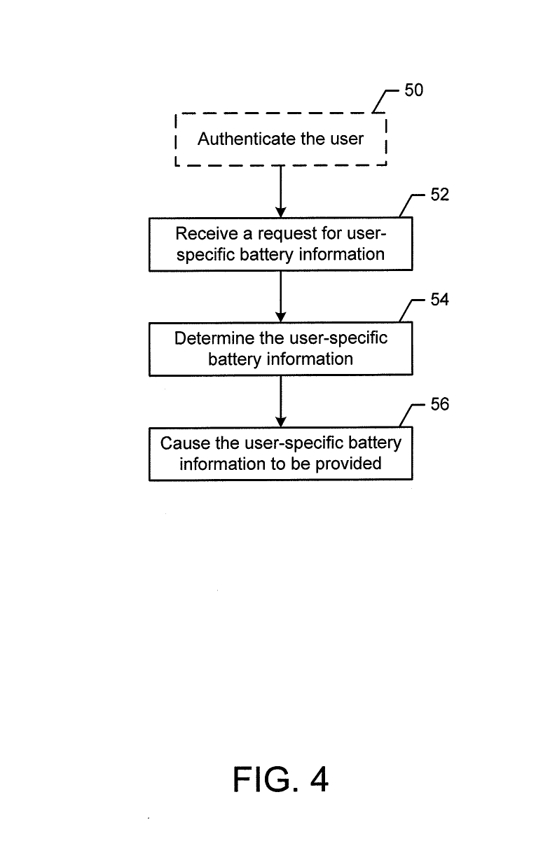

After the database server 12 has been populated with battery information from one or more users of one or more mobile terminals, the user of a mobile terminal 10 may request battery information from the database server. As described above, the requested battery information may either be specific to the user or may be non-user-specific. In an instance in which the requested battery information is user-specific, the apparatus 40 embodied by the database server may optionally include means, such as a processor 42 or the like, for authenticating the user. See block 50 of FIG. 4. Although the database server may authenticate the user in various manners, the apparatus embodied by the database server, such as the processor, may authenticate the user based upon a predefined access token provided by the mobile terminal as described above in conjunction with FIGS. 3.

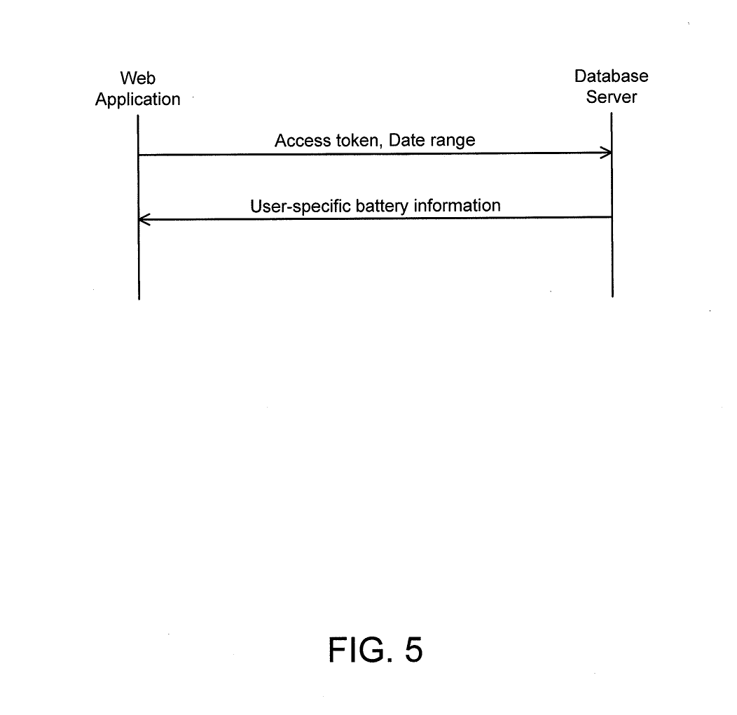

The apparatus 40 embodied by the database server 12 may also include means, such as a processor 42, the communication interface 46 or the like, for receiving a request for user-specific battery information. See block 52 of FIG. 4. Although the mobile terminal 10 may communicate directly with the database server in order to request the user-specific battery information, the mobile terminal of one embodiment is configured to interact with a web application 14 which, in turn, authenticates the user of the mobile terminal and issues a request for the user-specific battery information. In this regard, FIG. 5 illustrates a request for user-specific battery information provided by the web application to the database server. In the illustrated embodiment, the request for user-specific battery information includes an access token that permits the user of the mobile terminal to be authenticated by the database server and a date range of the user-specific battery information that is requested. However, the date range is optional and the request for user-specific battery information may eliminate the date range and may simply request all of user-specific battery information in some embodiments. Although not illustrated in FIG. 5, the request for user-specific battery information may also specify the type of user-specific battery information that is requested, such as user-specific use time, user-specific recharging time or the like.

The apparatus 40 embodied by the database server 12 may also include means, such as a processor 42, the memory 44 or the like, for determining the user-specific battery information that has been requested. See block 54 of FIG. 4. In one embodiment, the database server, such as the query server 20, may determine the user-specific battery information by accessing the aggregated user database 28 to retrieve the battery information specific to the user and responsive to the request. In other embodiments, however, the apparatus embodied by the database server, such as a processor, may process previously provided battery information in response to the request in order to generate the requested user-specific battery information. Thereafter, the apparatus embodied by the database server may include means, such as a processor, the communication interface 46 or the like, for causing the user-specific battery information to be provided. See block 56 of FIG. 4. As shown in FIG. 5, the user-specific battery information may be provided to a web application 14 which, in turn, may cause the user-specific battery information to be presented to the user, such as upon a display of the mobile terminal 10. Alternatively, the database server may provide the user-specific battery information directly to the mobile terminal in other embodiments.

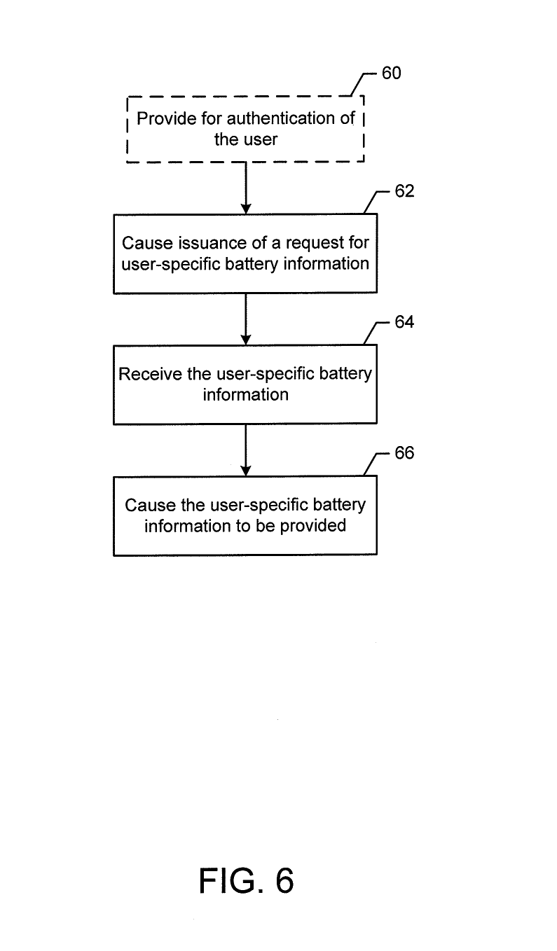

In regards to the provision of user-specific battery information, an apparatus 40 embodied by the mobile terminal 10 may also include means, such as a processor 42, the communication interface 46 or the like, for providing for authentication of the user. See block 60 of FIG. 6. In this regard, the mobile terminal may provide various credentials to an authentication server 16 in order to be authenticated and to obtain, for example, an access token as described above in conjunction with FIG. 3. The apparatus embodied by the mobile terminal may also include means, such as a processor, the communication interface or the like, for causing the issuance of a request for user-specific battery information. See block 62 of FIG. 6. This request may be issued directly to the database server 12, such as to the query server 20, or to a web application 14 which may, in turn, communicate with the database server on behalf of the mobile terminal. The request for user-specific battery information may identify the user in a manner that permits authentication of the user, such as providing the access token, and may identify the battery information that is requested, such as by date range, by the type of battery information or the like. The apparatus embodied by the mobile terminal may also include means, such as a processor, the communication interface or the like, for receiving the user-specific battery information. See block 64 of FIG. 6. In this regard, the mobile terminal may receive the user-specific battery information directly from the database server, such as from the query server, or from a web application that has interacted with the database server. The apparatus embodied by the mobile terminal may also include means, such as the processor, the user interface 48 or the like, for causing the user-specific battery information to be provided to the user, such as by presenting a display of the battery information. See block 66.

Based upon the battery information, the behavior of the user of the mobile terminal 10 may be guided. For example, in an instance in which the battery information is a use-time estimate, the user of the mobile terminal may judiciously use or execute the application so as to obtain the functionality provided by the application in a manner that preserves the energy stored by the battery. Additionally, or alternatively, in an instance in which the battery information includes a recharging time estimate, the user of the mobile terminal may provide for recharging of the mobile terminal in a timely manner. Although described above in conjunction with a request for and the subsequent provision of certain battery information, energy statistics, such as the energy statistics associated with a particular application, may additionally or alternatively be provided in another embodiment.

In addition to or instead of the user-specific battery information, a mobile terminal 10 may also request and receive non-user-specific battery information. Since the battery information is non-user-specific in this instance, the battery information may be considered insensitive and the user of the mobile terminal need not, in some embodiments, be authenticated. Although the battery information is not user-specific in this instance, the battery information may be specific to the type of device, that is, to the type of mobile terminal so as to be of increased relevance.

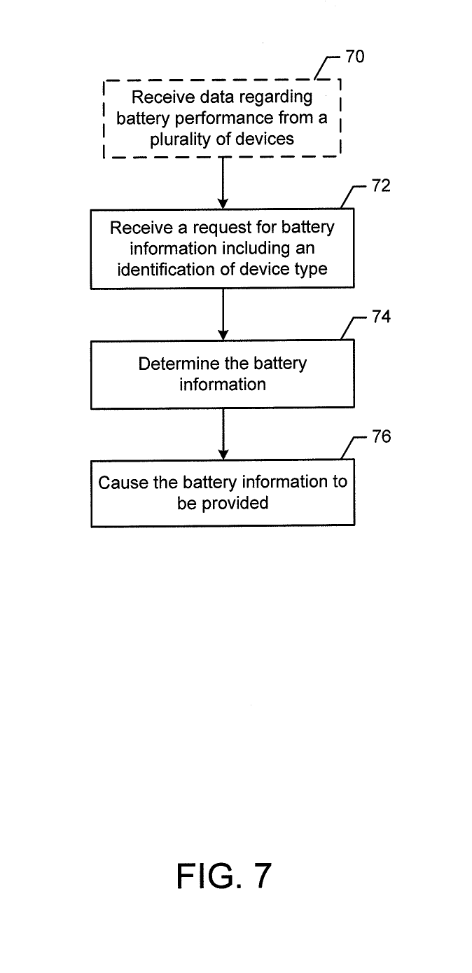

With reference now to block 70 of FIG. 7, the apparatus 40 embodied by the database server 12 may include means, such as the processor 42, the communication interface 46 or the like, for receiving data regarding battery performance from a plurality of mobile terminals. As described above in conjunction with FIG. 3, a plurality of mobile terminals may provide the database server with battery information along with an indication of at least the type of mobile terminal that is providing the battery information and, in some embodiments, the identity of the user of the mobile terminal that is providing the battery information. The database server, such as the upload server 22, may initially store the battery information in the raw database 24 and may then aggregate the data based upon device-type and/or user and may store the resulting aggregated data in the aggregated user database 28. As also described above, the mobile terminals may provide a wide variety of battery information including battery information relating to use time, power consumption of respective applications, recharging time, battery condition, a charging model or the like.

With respect to recharging time and battery condition, the database server 12 may receive a charging model for the mobile terminal 10 along with an identification of the type of mobile terminal. By aggregating the charging models for a plurality of mobile terminals of the same type, the apparatus 40 embodied by the database server, such as the processor 42, may determine a global or average charging model for the respective type of mobile terminal based upon an averaging or other aggregation of the charging models provided by the plurality of mobile terminals of the respective type. In this regard, the mobile terminal may record each charging event and may provide information regarding each charging event as well as the charging model for the mobile terminal to the database server. The mobile terminal may provide a variety of information regarding the charging event including, for example, the stored energy at the start of charging, the stored energy at the completion of charging, the percentage of stored energy at the start of charging relative to the capacity of the battery, the percentage of stored energy at the completion of charging relative to the capacity of the battery, the duration of the charging event and the charger type.

In regards to the construction of the global charging model, the apparatus 40 embodied by the database server 12, such as the processor 42, may determine separate charging models for the battery condition and for the type of device, since both affect the recharging time. As such, a recharging model may be identified as <M,C> with M being the type of device, that is, the device model, and C being the battery condition class, e.g., good, intermediate or bad. The apparatus embodied by the database server, such as the processor, may update the charging models by receiving M, C, the battery percentage trace (T) from the recharging table and the maintenance mode length (L) and then selecting the proper charging model based upon <M,C>. The apparatus embodied by the database server, such as the processor, may then determine the validity of T and L since, for example, a broken battery pack may provide invalid samples. The apparatus embodied by the database server, such as the processor, may then update the charging model for <M,C> as described below. In this regard, a stochastic updating of the charging model may be advantageous since there are many sources of information, such as from different mobile terminals. In addition to determining the charging model, the apparatus embodied by the database server, such as the processor, may determine the battery condition which, in some embodiments, may also be at least partially based upon the age of the battery based upon, for example, the identity, e.g., the IMEI, of the mobile terminal and a comparison of the battery capacity relative to a 100% capacity.

The apparatus 40 embodied by the database server 12, such as the processor 42, may determine the recharging time based upon a plurality of factors including, for example, the age and type of battery 49, the type of recharger that is utilized, the temperature and/or features unique to a specific battery. Although it may be possible to physically model a battery so as to integrate from the current the remaining charge of the battery after a fixed time interval, the factors that affect the recharging time are not static, but dynamic so as to make it difficult to construct an accurate physical model of the battery. Additionally, a physical model may create scalability challenges in that the model may need to be adapted for each target device. As such, a method, apparatus and computer program product of one embodiment may cause battery information, such as recharging time, to be determined in a manner that readily adapts to a respective mobile terminal 10.

In this regard, the charging process of a mobile terminal 10 can be separated into a charging mode and a maintenance mode. In the charging mode, the voltage increases as the battery is charged. During the charging mode, the estimated energy level of the battery can be determined, such as by cumulatively counting the amount of energy during charging based on the current samples. In this embodiment, the percentage value of energy may calculated by dividing with the full battery capacity. By way of example, while recharging during the charging mode, the recharging current may be monitored. The amount of increase in energy in the battery may be calculated by:

ΔE=iΔt,

where i is the recharging current and Δt the amount time between the previous and the new current sample. The total amount of energy in the battery is then

Eₜₒₜ=Eₚ+ΔE,

where Eₚ is the previous total amount of energy before ΔE. The energy may then be linearly converted into battery level in the range of [0,100].
After the charging mode, the mobile terminal may enter into a maintenance mode in which the voltage may vary depending on the charger, and finally the battery may become fully charged. For modeling of the charging process, it may be assumed that a charging level of 90-100% has been reached at the start of the maintenance mode.

As described below, the method, apparatus and computer program product of an example embodiment may utilize samples from the charging level percentage progression for dynamically updating the recharging time estimate. The method, apparatus and computer program product of one embodiment may also be configured to adapt to the charger that is used and, as such, is able to determine the recharging time estimate for different types of chargers.

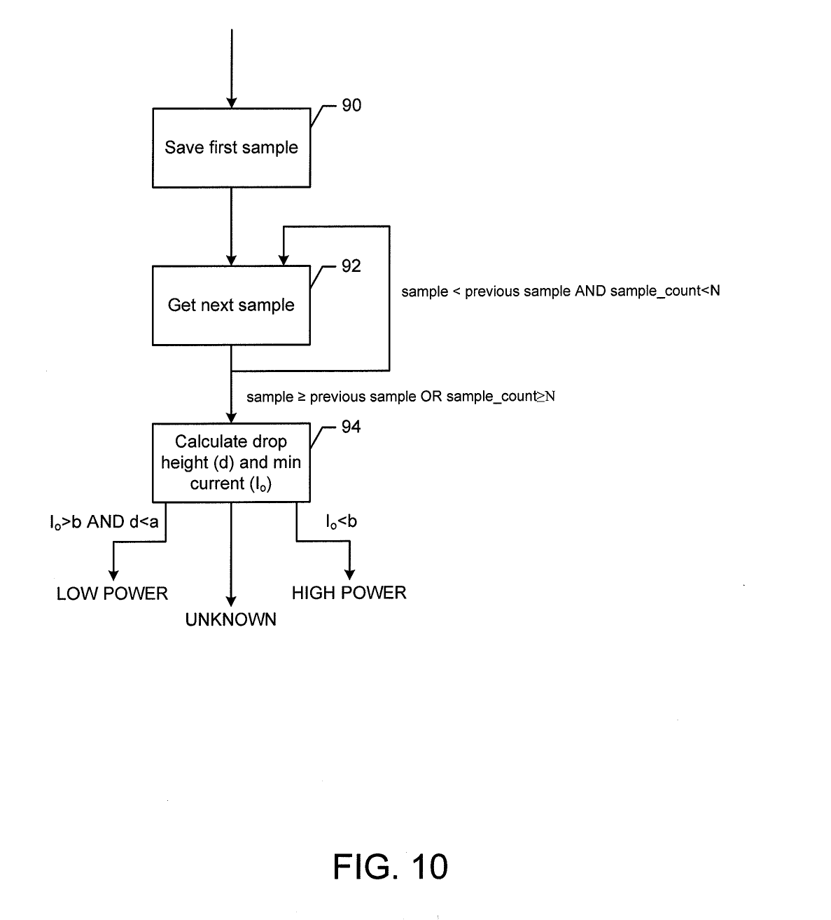

In one embodiment, in an instance in which a charger is connected to the mobile terminal 10, the apparatus 40 embodied by the mobile terminal, such as the processor 42, may receive an indication of an event representative of the connection of the charger to the mobile terminal. The value of current upon receipt of the event is denoted as I₀ and is determined by the apparatus, such as the processor, as shown in block 90 of FIG. 10. In some, but not necessarily all instances, the current may become negative within a few samples after connecting the charger to the mobile terminal. Indeed, the current may remain positive and need not necessarily become negative within a few samples after connecting the charger to the mobile terminal. For purposes of example, but not of limitation, an embodiment in which the current does become negative within a few samples after connecting the charger to the mobile terminal is described below. In this embodiment, the minimum value of current may be searched as shown in block 92 by examining a predetermined number N, e.g., 20, of current samples so long as the current continues to decrease, e.g., Iₙ<Iₙ₋₁ wherein n is the order number of the current sample, e.g., n=1, 2, . . . , N. Once the predetermined number of current samples have been examined or the current no longer decreases, the apparatus embodied by the mobile terminal, such as the processor, may classify the type of charger as shown in block 94 based upon one or two features, namely, d=Iₙ−I₀ which is a measure of a change, e.g., a decrease, in the current from a first sample, e.g., the initial sample, until a second sample, e.g., the n^{th} sample and Iₙ which is the minimum value of current within the examined window. Based upon these features, he method, apparatus and computer program product may classify the type of charger into one of two categories (High or Low) by:

$$C = \{ \begin{matrix}{C}_{high} , {I}_{n} < b \\ {C}_{low} , d < a ⋀ {I}_{n} \geq b ,\end{matrix} \\ where a , b ∈ R .$$

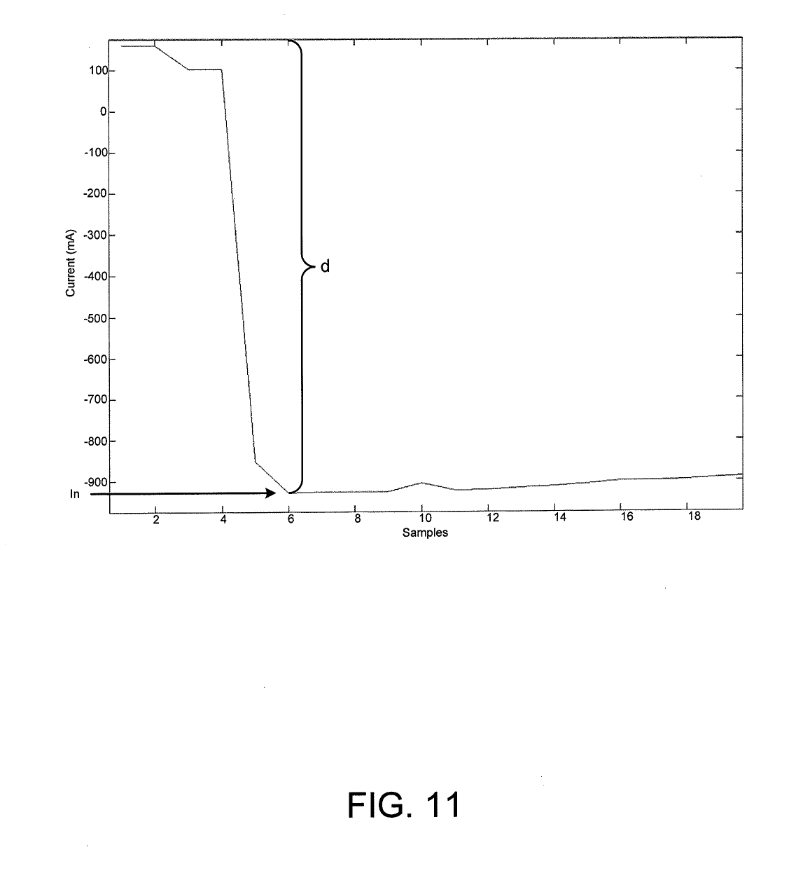

See also FIG. 11 for illustration of Iₙ and d. After the charger type is detected, the apparatus, such as the processor, may be configured to update the recharging time.

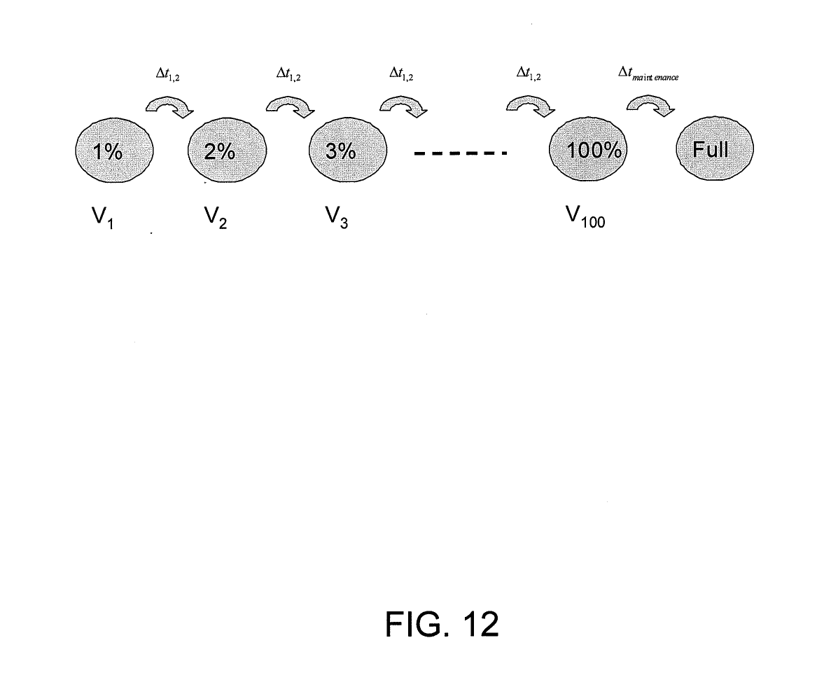

By way of explanation, Vᵢ, i=1, . . . , 100 is a vector of real numbers. Each element Vᵢ contains an estimate for the remaining recharging time in some relevant time units, e.g., in seconds. The recharging process can be modeled as a Markov chain as shown in FIG. 12. During the recharging process, the recharging state may change dynamically and for each state transition there may be an associated delay. The states correspond to the recharging time estimates Vᵢ and the delays are denoted as Δt_{i,j}. For example, if the battery level changes from 78% to 79%, the state may change from V₇₈ to V₇₉ and the associated delay is Δt_{78,79}.

The estimate for Vᵢ may be changed according to Bellman's equation as follows:

Vᵢ=Δt_{i,j}+Vⱼ

or if it is assumed that Δt_{i,j} changes substantially over time, the following stochastic version of the estimate update rule can be applied:

Vᵢ(t+1)=(1−α)Vᵢ(t)+α(Δt_{i,j}+Vⱼ(t)),

in which case the estimate converges to the mean estimated recharging time rather than varying significantly over time. In the foregoing example, the update rules may have the following form:

V₇₈=Δt_{78,79}+V₇₉

and

V₇₈ (t+1)=(1−α)V₇₈ (t)+α(Δt_{78,79}+V₇₉(t)).

In state V₁₀₀, the battery is fully charged, but the battery may still require some time to finalize recharging in the maintenance mode. As such, state V₁₀₀ represents the goal state in the related Markov chain and is therefore denoted as follows:

V₁₀₀=Mⱼ where Mⱼ is the maintenance mode length.

The battery level may sometimes jump over several percentages, for example from 78% to 80%. In this instance, the whole trace can be updated by interpolation as follows:

$${V}_{78} = \frac{Δ {t}_{78 , 80}}{2} + {V}_{79}$$

$${V}_{79} = \frac{Δ {t}_{78 , 80}}{2} + {V}_{80}$$

Additionally, if the percentage drops for some reason, the update procedure may be discarded as the situation is abnormal, and potentially represents a malfunction.

In one embodiment, the maintenance mode length may be designated Mⱼ, j=1, . . . , 100, which is a vector of real numbers representing the battery level at the beginning of the charging process. After each complete recharging of the battery, Mⱼ₊₁=t_{maintenance}_{_{—}}_{end}_{_{—}}ₜᵢₘₑ−t_{maintenance}_{_{—}}ₛₜₐᵣₜ_{_{—}}ₜᵢₘₑ is updated according to the beginning percentage j. The elements may be updated surrounding j in a range └Mⱼ₋ᵣ, Mⱼ₊ᵣ┘ where r ∈ R is the update radius. The updating may be accomplished by first defining the update range as: k ∈ [j+1−r, j+1+r] and d=j+1+k. With α defined as

$$a = \{ \begin{matrix}- \frac{d}{r} + 1 , d \geq 0 \\ \frac{d}{r} + 1 , d < 0 ,\end{matrix}$$

the updated maintenance mode model may then be represented as: Mₖ=αMⱼ₊₁+(1−α)Mₖ.

Two sets of Vᵢ, i=1, . . . , 100 and Mⱼ, j=1, . . . , 100 may be initialized before the first updating, e.g., charging, process, one for each charger type. The initialization values may differ from each other in these two sets since they are customized to represent the charger type. According to the charger detection result C, the appropriate V and M may be updated.

The apparatus 40 embodied by the mobile terminal 10, such as the processor 42, may apply filtering to the recharging time updating. The value of the recharging current may be monitored during recharging at each transition and two conditions may be checked before making updates to Vᵢ, namely, e<mean(Iₙ . . . Iₘ)<f and var(Iₙ . . . Iₘ)<g where n is the order number of the current sample at the beginning of battery level i and m is the order number of the sample at the end, and where e and f are specific for the charger type. By monitoring the mean current, instances in which the charger type has been incorrectly recognized may be filtered out from the recharging time updating process.

Some chargers, such as a dynamo powered bicycle charger, provide unstable charging current. Since the recharging current varies, Δt_{i,j} may be arbitrary for these chargers. However, the variance calculation and filtering according to a threshold value g prevents these chargers from effecting the recharging time model.

The apparatus 40 embodied by the mobile terminal 10, such as the processor 42, may estimate the total remaining recharging time by using formula T_{RRT}(i,j)=V(i)+M(j) where i is the current battery level during recharging and j the battery level in the beginning of recharging.

The delay for recharging time estimates (Vᵢ) can be determined during the recharging process based on the time fetched from the system clock of the mobile terminal 10. For calculation of the recharging time estimate of the maintenance mode (C₁₀₀), a ‘battery charging complete’ indication may be provided. The recharging times that are determined in multiple recharging iterations may be updated based on a moving average, which enables adaptation to changes in the battery status, e.g., caused by aging.

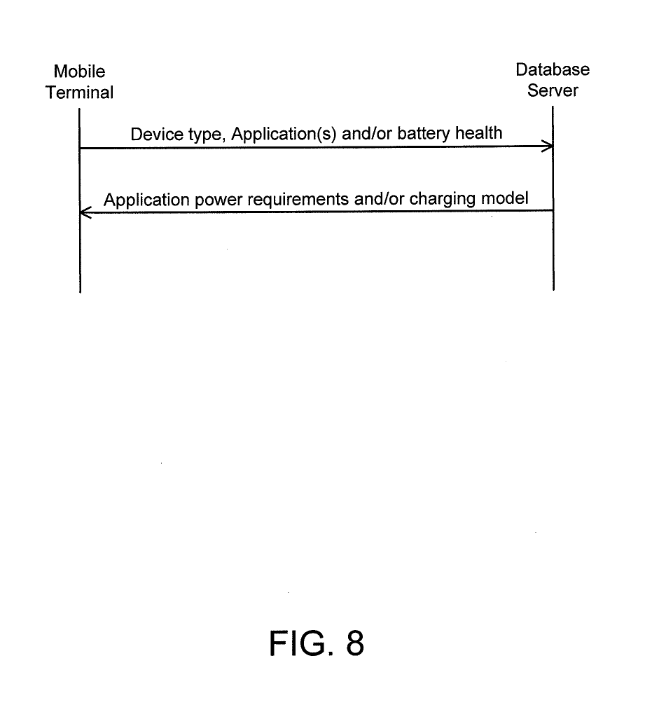

Returning now to FIG. 7, the apparatus 40 embodied by the database server 12 may also include means, such as a processor 42, a communication interface 46 or the like, for receiving a request for battery information including an identification of device type. See block 72 of FIG. 7. With reference now to the signal flow diagram of FIG. 8, the mobile terminal 10 is shown to issue a request for battery information to the database server. This request includes an identification of device type. Additionally, the request for battery information may indicate the type of battery information that is requested. For example, the request may indicate that the battery information that is solicited relates to use time estimates and/or recharging time estimates. In an instance in which the request for battery information relates to use time estimates, the request may also include an identification of each application for which a use time estimate is desired. In this regard, the applications may be identified by respective, unique identifiers (IDs). In an instance in which the request for battery information relates to a request for a recharging time estimate, the request may also optionally include an indication of the battery health, such as good, bad or intermediate.

The apparatus 40 embodied by the database server 12 may also include means, such as the processor 42 or the like, for determining the battery information that has been requested. See block 74 of FIG. 7. In one embodiment, the database server, such as a query server 20, may determine the requested battery information by accessing the aggregated user database 28 in order to retrieve the requested battery information. In an instance in which the requested battery information relates to use time estimates, a use time estimate for each identified application when executed by a mobile terminal 10 of the respective device type may be retrieved. In this embodiment, the apparatus embodied by the database server, such as the processor, may also or alternatively determine other types of battery information including the average power consumption of an application. The power consumption of an application may be provided to the mobile terminal as shown in FIG. 8 to permit the mobile terminal to determine the use time estimate for the respective application. Additionally or alternatively, in an instance in which the requested battery information is a recharging time estimate, a recharging time estimate for a mobile terminal of the respective device type, may be retrieved. The apparatus embodied by the database server, such as the processor, may also or alternatively determine other types of battery information including an average charging model for the respective device type and/or an indication of the battery health. The charging model may be provided to the mobile terminal as also shown in FIG. 8 to permit the mobile terminal to determine the recharging time estimate. As noted above, the battery information that is determined in accordance with this embodiment is not specific to the user, but may, instead, be based upon battery information provided by a plurality of devices of the same type and, as such, may be representative of the average behavior of a device of the respective type.

The apparatus 40 embodied by the database server 12 may also include means, such as the processor 42, the communication interface 46 or the like, for causing the battery information to be provided to the mobile terminal 10. See block 76 of FIG. 7. As shown in FIG. 8, for example, the database server, such as a query server 20, may cause battery information, such as use time estimate and/or a recharging time estimate, to be provided to the mobile terminal.

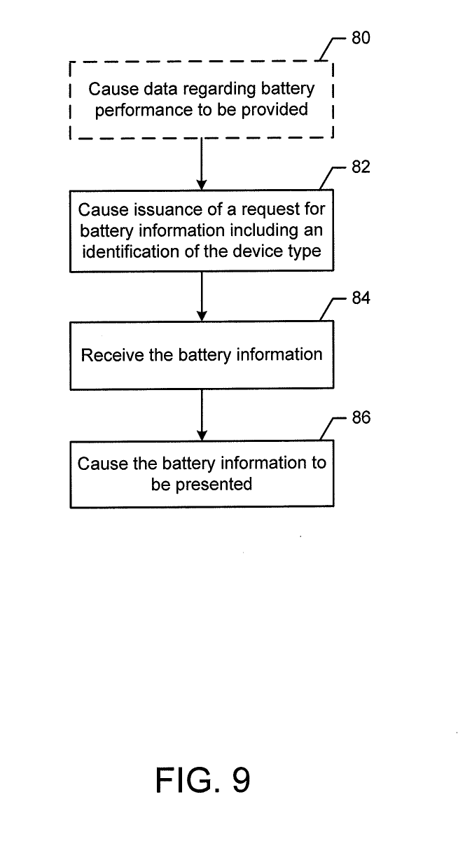

From the perspective of the mobile terminal 10, an apparatus 40 embodied by the mobile terminal may include means, such as the processor 42, the communication interface 46 or the like, for causing data regarding battery performance to be provided to the database server 12. See block 80 of FIG. 9. Further details regarding the provision of data regarding battery performance from a mobile terminal to a database server is provided by U.S. patent application Ser. No. 13/095,078 filed Apr. 27, 2011, the contents of which are incorporated herein by reference in their entirety. By providing data regarding battery performance to the database server, the database server may maintain user-specific battery information for subsequent access and review by the mobile terminal. Additionally, by providing data regarding battery performance to the database server, the database server can combine the data regarding battery performance provided by the respective mobile terminal with similar data regarding battery performance provided by other mobile terminals of the same type in order to provide battery information in an aggregated manner to each of the mobile terminals.

The apparatus 40 embodied by the mobile terminal 10 may also include means, such as the processor 42, the communication interface 46 or the like, for causing issuance of a request for battery information including an identification of the device type. See block 82 of FIG. 9, as well as FIG. 8 described above. The request for battery information may also define the type of battery information that is requested, such as a use time estimate and/or recharging time estimate. In regards to a use time estimate, the request for battery information may also identify one or more applications for which a use time estimate is requested. The apparatus embodied by the mobile terminal may also include means, such as the processor, the communication interface or the like, for receiving the battery information and means, such as the processor, the user interface 48 or the like, for causing the battery information to be presented to the user, such as by displaying at least some of the information for the user. See blocks 84 and 86 of FIG. 9.

The battery information may then guide the usage of the mobile terminal 10 so as to judiciously utilize the remaining energy stored within the battery and to provide for recharging of the battery in a timely manner. Additionally, a mobile terminal may also be able to retrieve relevant battery information for a respective application almost immediately upon the installation of the respective application and reliable information regarding the battery health may be obtained from the database server based upon battery information provided by many mobile terminals. As such, the condition of a battery 49 may be more accurately determined, even in instances in which the battery is unhealthy and is performing in an unpredictable manner.

Although the mobile terminal 10 may determine the battery health including the battery condition and may provide information regarding the battery health to the user, the mobile terminal and/or the database server 12 may provide the battery information to a network entity, such as battery health analysis server, that may analyze the battery information, including, for example, the charging model, and may determine the battery health including the battery condition. The battery health analysis server of this example embodiment may then provide information regarding the battery health analysis including the battery condition to the user who may decide whether to replace, recharge or otherwise manage the battery 49. Although the battery health analysis server may be distinct from the database server, the database server may embody the battery health analysis server so as to perform the battery health analysis and to provide the resulting information to the user.

As described above, FIGS. 4, 6, 7, 9 and 11 are flowcharts of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the operations described herein may be embodied by computer program instructions of a computer program product. In this regard, the computer program product(s) which embody the operations described herein may be stored by one or more memory devices 44 of a mobile terminal 10, a database server 12 or the like and executed by a processor 42 in the respective device. In some embodiments, the computer program instructions comprising the computer program product(s) which embody the operations described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

In some embodiments, certain ones of the operations above may be modified or further amplified. Furthermore, in some embodiments, additional optional operations may be included, such as by shown by the blocks with dashed outlines in FIGS. 4, 6, 7 and 9. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, although described herein in the context of a mobile terminal, the method, apparatus and computer program product of some example embodiments may also interact with one or more stationary devices that operate under battery power so as to have users who are interested in the battery information, such as use time and recharging time estimates. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving a request for battery information, wherein the request comprises an identification of a device type, and wherein the battery information comprises at least one of a use time estimate or a recharging time estimate;
determining the battery information that was requested based upon data regarding at least one of use time or recharging time for a plurality of different devices of the device type; and causing the battery information to be provided.

2. A method according to claim 1 wherein receiving the request comprises receiving the request for a use time estimate including an identification of a respective application, and wherein determining the battery information comprises determining the use time for the respective application.

3. (canceled)

4. A method according to claim 1 wherein the battery information comprises at least one of an average charging model and an indication of battery health.

5. A method according to claim 1 further comprising receiving data regarding battery performance from a plurality of devices, wherein determining the battery information comprises determining the battery information based upon the data regarding battery performance received from the plurality of devices.

6. (canceled)

7. A method according to claim 1 further comprising:
receiving a request for user-specific battery information, wherein the request comprises an identification of a respective user;
determining the user-specific battery information; and
causing the user-specific battery information to be provided.

8. (canceled)

9. An apparatus comprising at least one processor and at least one memory including computer program code, the at least one memory and the computer program code configured to, with the at least one processor, cause the apparatus to at least:
receive a request for battery information, wherein the request comprises an identification of a device type, and wherein the battery information comprises at least one of a use time estimate or a recharging time estimate;
determine the battery information that was requested based upon data regarding at least one of use time or recharging time for a plurality of different devices of the device type; and cause the battery information to be provided.

10. An apparatus according to claim 9 wherein the at least one memory and the computer program code are configured to, with the at least one processor, cause the apparatus to receive the request by receiving the request for a use time estimate including an identification of a respective application, and wherein the at least one memory and the computer program code are configured to, with the at least one processor, cause the apparatus to determine the battery information by determining the use time for the respective application.

11. (canceled)

12. An apparatus according to claim 9 wherein the battery information comprises at least one of an average charging model and an indication of battery health.

13. An apparatus according to claim 9 wherein the at least one memory and the computer program code are further configured to, with the at least one processor, cause the apparatus to receive data regarding battery performance from a plurality of devices, and wherein the at least one memory and the computer program code are configured to, with the at least one processor, cause the apparatus to determine the battery information by determining the battery information based upon the data regarding battery performance received from the plurality of devices.

14. (canceled)

15. An apparatus according to claim 9 wherein the at least one memory and the computer program code are further configured to, with the at least one processor, cause the apparatus to:
receive a request for user-specific battery information, wherein the request comprises an identification of a respective user;
determine the user-specific battery information; and
cause the user-specific battery information to be provided.

16-33. (canceled)

34. A method comprising:
causing issuance of a request for battery information, wherein the request comprises an identification of a device type, and wherein the battery information comprises at least one of a use time estimate or a recharging time estimate;
receiving the battery information that was requested based upon data regarding at least one of use time or recharging time for a plurality of different devices of the device type; and causing the battery information to be presented.

35. A method according to claim 34 wherein causing the issuance of the request comprises including an identification of a respective application in the request such that the use time comprises the use time for the respective application.

36. (canceled)

37. A method according to claim 34 wherein the battery information comprises at least one of an average charging model and an indication of battery health.

38. (canceled)

39. (canceled)

40. A method according to claim 34 further comprising:
causing issuance of a request for user-specific battery information, wherein the request comprises an identification of a respective user;
receiving the user-specific battery information; and
causing the user-specific battery information to be presented.

41. (canceled)

42. A method according to claim 34 further comprising classifying a type of charger that is utilized to recharge a battery.

43. (canceled)

44. An apparatus comprising at least one processor and at least one memory including computer program code, the at least one memory and the computer program code configured to, with the at least one processor, cause the apparatus to at least:
cause issuance of a request for battery information, wherein the request comprises an identification of a device type, and wherein the battery information comprises at least one of a use time estimate or a recharging time estimate;
receive the battery information that was requested based upon data regarding at least one of use time or recharging time for a plurality of different devices of the device type; and cause the battery information to be presented.

45. An apparatus according to claim 44 wherein the at least one memory and the computer program code are configured to, with the at least one processor, cause the apparatus to cause the issuance of the request by including an identification of a respective application in the request such that the use time comprises the use time for the respective application.

46. (canceled)

47. An apparatus according to claim 44 any one of claims 11 to 46 wherein the battery information comprises at least one of an average charging model and an indication of battery health.

48. (canceled)

49. (canceled)

50. An apparatus according to claim 44 wherein the at least one memory and the computer program code are further configured to, with the at least one processor, cause the apparatus to:
cause issuance of a request for user-specific battery information, wherein the request comprises an identification of a respective user;
receive the user-specific battery information; and
cause the user-specific battery information to be presented.

51. (canceled)

52. (canceled)

53. (canceled)

54. An apparatus according to claim 44 wherein the at least one memory and the computer program code are further configured to, with the at least one processor, cause the apparatus to classify a type of charger that is utilized to recharge a battery.

55-75. (canceled)
